(19) United States
(12) Patent Application Publication
(10) Pub. No.: US 2006/0026835 A1
(43) Pub. Date: Feb. 9, 2006

(54) Heat exchanger fins and method for fabricating fins particularly suitable for stirling engines

(76) Inventor: James Gary Wood, Albany, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/910,323

(22) Filed: Aug. 3, 2004

(51) Int. Cl. B23P 15/26

(52) U.S. Cl. 29/890.048

(57) ABSTRACT

Heat exchanger fins and a method for fabricating fins particularly suitable for the head of Stirling engine. The fins have a frusto-conical contour and surround and are brazed to the heater head at axially spaced positions. The inner edges of the fins are rolled to provide a flange for engaging and being joined to the head and have axially aligned, radial slots cut into the outer edge to provide channels for the passage of the products of heater combustion. The fins can be formed of annular rings or from a ribbon bent into a helix.

### BACKGROUND OF THE INVENTION

1. Field of the Invention

This invention relates generally to heat exchangers and more specifically, to simple fin structures for heat exchangers and a method for manufacturing fins for facilitating heat transfer.

2. Description of the Related Art

Heat exchangers are commonly used in a variety of machines to improve the heat transfer rate from a mass at a higher temperature to a mass at a cooler temperature.

Axially spaced fins are a well know heat exchanger structure and are commonly used for cooling a component of a machine, such as the cylinder of a small, air cooled, internal combustion engine, by transferring heat from the machine component to the surrounding atmosphere. Fins have also been used to assist in the transfer of heat from a heat source, such as a gas burner, into an external combustion machine, such as a free piston Stirling engine. Fins are effective because they provide highly thermally conductive paths through the metal of the fins to or from a greatly increased surface area for interfacing with a source or sink for thermal energy.

Heat exchanger fins are typically sheets, panels, arms or other structures that protrude from a mass and present extended surface areas for the exchange of heat. They are made of materials of high thermal conductivity and durability, usually metal. When fins are designed to transfer heat to or from a generally cylindrical object, such as the head of an engine, they are typically formed as a series of axially spaced, parallel, planar surfaces with a circular or other peripheral contour that generally parallels the peripheral contour of the head. While such fins are often cast into the head, in many applications they are fabricated independently and then assembled onto and welded or brazed to the head. Fins which are formed of parallel planar surfaces are desirable for optimizing the transfer of heat from an engine head to a surrounding fluid but are not optimal for transferring heat from a surrounding gas burner into the head.

In the design of the head of a Stirling engine, a shorter head length reduces thermal hysteresis losses because the shorter head length reduces internal volume and internal area. However, the head length also must be long enough to expose a peripheral head area to an external burner that is sufficient to transfer enough heat into the head for adequately powering the engine. The use of heat exchanger fins to facilitate heat transfer into the head allows the head length to be reduced from the length that would be required if there were no fins but further reduction would be desirable.

Fins formed from sheet material are typically die cut or otherwise cut from a large piece of sheet stock. This results in waste material within their center, which is removed to receive and engage the head, and, unless the fins have a square or rectangular outer periphery, there is further waste material at their corners.

Therefore, it is an object and feature of the invention to provide fin structures which improve heat transfer characteristics when used to assist in the transfer of heat into an engine.

Another object and feature of the invention is to provide fin structures which lengthen the effective heat transfer area without requiring a corresponding physical lengthening of the head itself and therefore allow the head length to be shortened.

Yet another object and feature of the invention is to provide a fin structure which reduces the amount of waste of the stock material from which the fins are fabricated.

Yet a further object and feature of the invention is to provide a fin structure and a method for their manufacture which is less expensive and provides a fin structure that is easily fit and then brazed to the head.

### BRIEF SUMMARY OF THE INVENTION

The heat exchanger of the invention has a plurality of axially spaced fins, each fin formed of a thermally conductive sheet and having a substantially frusto-conical contour. Preferably, each fin has an inner flange rolled axially along an inner edge of the fin to form a surface for joining to a mass such as the head of a Stirling engine. A plurality of radial slots are preferably formed in the fins and are aligned in the axial direction to allow for combustion products to pass through the fins in the axial direction. The fins can be formed by cutting a planar sheet into rings and then forming the rings into the substantially frusto-conical contour or by bending a ribbon into a helix and into a substantially frusto-conical contour. Lateral slots may be formed into the ribbon to facilitate bending into the helix and may be aligned on the head to allow the axial flow of combustion products.

### BRIEF DESCRIPTION OF THE SEVERAL VIEWS OF THE DRAWINGS

FIG. 1 is a view in cross-section of a Stirling engine having a head that is joined to fins embodying the present invention.

FIG. 2 is an enlarged view in cross-section of a segment of the embodiment of FIG. 1.

FIG. 3 is view in perspective of a segment of a ribbon with lateral slots for forming a helical fin embodying the invention.

FIG. 4 is view in perspective of the ribbon segment illustrated in FIG. 3 but also having an edge rolled to form a flange.

FIG. 5 is a view in perspective of a ribbon, like that illustrated in FIG. 4 bent along a helix and having a substantially frusto-conical contour.

In describing the preferred embodiment of the invention, which is illustrated in the drawings, specific terminology will be resorted to for the sake of clarity. However, it is not intended that the invention be limited to the specific term so selected and it is to be understood that each specific term includes all technical equivalents, which operate in a similar manner to accomplish a similar purpose.

### DETAILED DESCRIPTION OF THE INVENTION

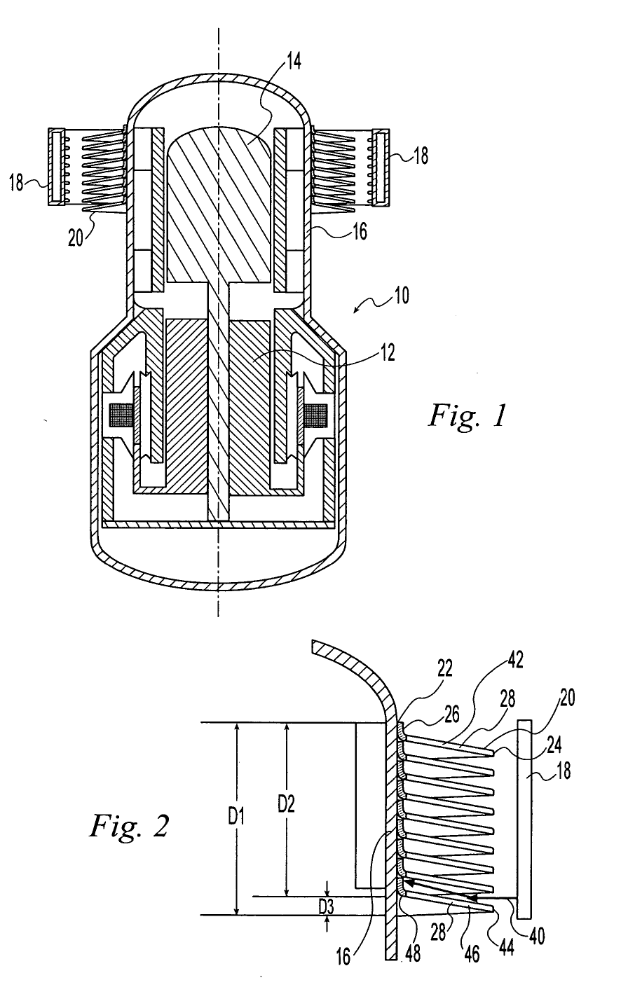

FIG. 1 illustrates a free piston Stirling engine 10 having a conventional power piston 12 and a displacer 14, which reciprocates in an engine head 16. The engine is powered by heat applied from a ring burner 18 surrounding the head 16. The heat is supplied by burner flames fueled by gas supplied into an interior chamber of the burner 18 from a fuel source and expelled through a matrix of orifices to each flame. The transfer of heat into the Stirling engine head 16 causes the alternate expansion and contraction of a working gas within the Stirling engine in accordance with well established principles of Stirling engine operation.

In order to improve the rate and efficiency of heat transfer into the head, it is known in the prior art to provide a heat exchanger on the exterior of the head 16. Thermally conductive, axially spaced fins surrounding and attached to the head of a Stirling engine have been used for such heat exchangers. Such fins are usually planar and extend radially outwardly from the head. However, each of the fins 20 of the present invention has a substantially frusto-conical contour. Like the prior art, they preferably surround the head 16 so that the heat from the flames of the ring heater 18 can impinge upon them. They are preferably formed from stainless steel or aluminum bronze for use with a Stirling engine.

Referring in more detail to FIG. 2, each fin has an inner edge 22 and an outer edge 24. An inner flange 26 is formed along the inner edge 22 such as by rolling the inner edge 22 axially to provide a surface for joining to the heater head 16. Joining to the head 16 is accomplished by conventional methods such as welding and other known methods for joining materials that provides both mechanical strength and thermal conductivity, but preferably is done by brazing. The flanges are preferably rolled with a moderate radius and preferably are bent to an obtuse angle with the frusto-conical surfaces of the fin and in a direction opposite to the direction in which the frusto-conical surfaces of the fins extend. This configuration provides an inner surface of the flange for engagement with the head 16 and eases the brazing operation but requires less bending and therefore causes less strain of the fin material. However, the flanges can be rolled at an acute angle in the opposite direction. The flanges can be rounded as illustrated or they can have a cylindrical contour and can be bent around a smaller radius compatible with the ductility of the metal.

Preferably, a plurality of radial slots 28 are formed in the fins and are axially aligned to permit combustion products from the burner flames to pass axially through the fins. These combustion products flow through the slots 28 by convection when the head 16 is oriented vertically and also flow as a result of the pressure of the continuous flow of gas out of the burner 18. The slots 28 are angularly spaced around the fins, for example at angular intervals of every 5° to 30°. As an alternative, slots may be formed in the fins but arranged in a staggered or non-aligned manner. This slows down the flow rate of gases through the slots transversely of the fins but the resulting more tortuous path provides more flow between the fins.

The fins can be formed in a variety ways. According to the method of the invention a thermally conductive sheet is formed into a substantially frusto-conical contour and, either before or after that forming step, an edge of the sheet is rolled to form the flange along an interior edge of the frusto-conical fin. The embodiment of FIG. 1 is preferably formed by cutting a thermally conductive planar sheet into plurality of rings and then rolling the inside edge of each ring to form the flange. Either before or after the rolling step each ring is bent into a frusto-conical contour. Because the finished rings should conformably seat against the exterior surface of the head 16, they should be cut and their inside edges rolled so that the inside diameter of each ring is substantially equal the outside diameter of the head. These rings are then positioned in axially spaced arrangement along the head 16 and joined to it as illustrated in FIG. 1.

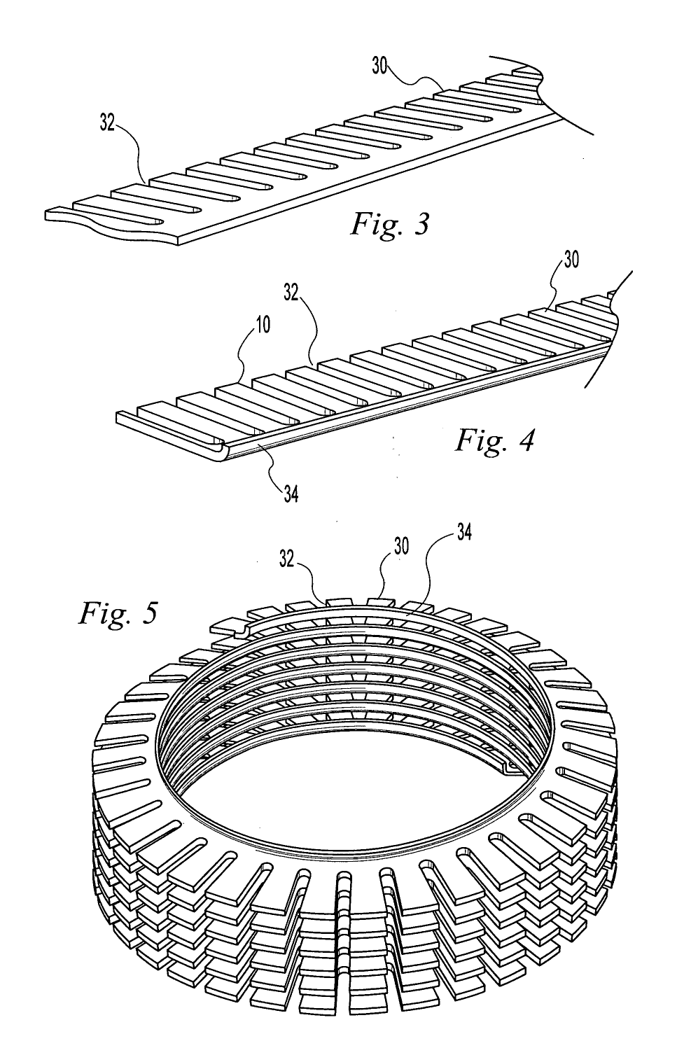

Another way of forming the fins is illustrated in FIGS. 3-5. It begins with a thermally conductive sheet that is a metal ribbon 30. FIGS. 3 and 4 illustrate a short segment of that ribbon 30. A plurality of spaced, lateral slots 32 are cut, such as by die cutting, into one edge of the ribbon. These slots 32 extend partially across the ribbon 30. The opposite edge of the ribbon 30 is rolled to form a flange 34. The operation of cutting the slots and rolling the edge to form the flange can be performed in either order. The ribbon is then bent into the substantially frusto-conical contour and to extend lengthwise along a helix with the flange on the inside edge of the ribbon and the slots opening outwardly to form a helical fin structure as illustrated in FIG. 5. The operations of bending the ribbon into a helix and bending the ribbon into a substantially frusto-conical contour can be performed simultaneously or in either order. The ribbon 30 should be bent into a helix that has an inside diameter that is substantially equal to the outside diameter of the head so that it can be conformingly joined along its flange 34 to the head of the Stirling engine. The radial slots 32 formed in the ribbon facilitate bending of the ribbon into the somewhat circular shape of a helix and they can be aligned axially, as illustrated in FIG. 5 to provide a channel for the flow of combustion products, like the slots 28 illustrated in FIG. 2. Although the bending of a single ribbon into a helix could in one sense be viewed as a single fin, it is believed appropriate to view such a helical fin structure as a plurality of fins because, when observed, they appear to be plural fins and are equivalent to a plurality of fins when the helix has multiple turns.

The bending and forming operations of the invention can be performed in the conventional ways familiar to those in the metal working art. For example, bending and forming can be accomplished with forming dies in a stamping or forging operation. Bending can also be accomplished by rolling the material between contoured rollers. The helical configuration can also be obtained using methods analogous to the formation of helical springs.

The term “substantially frusto-conical” is used to avoid the impression that the fins must conform strictly or in their entirety to the precise definition of a cone as used in the mathematical science of geometry. For example, a ribbon formed into a helical, frusto-conically contoured fin that is collapsed or compressed onto itself may form a stack of essentially conical surfaces but when expanded into axially spaced relationship those surfaces no longer lie along the surfaces of ideal cones. However, they are close and that is all that is necessary to acquire the advantages of the invention. Similarly, the substantially frusto-conical surfaces can also have some rounded or arced curvature although this is believed unnecessary. The frusto-conical surfaces may also have additional structural features, such as tabs or additional flanges extending from the fins, some flat spots or minor areas of a different contour. They may also have cutout portions such as notches. The advantages of the invention are available despite minor departures from a mathematically precise frusto-conical contour.

The frusto-conical contour provides at least two advantages over conventional planar fins when used in a Stirling or other external combustion engine. The first is the trapping of thermal radiation and the second is the effective lengthening of the heat exchanger without requiring a corresponding lengthening of the head 16 to which it is attached.

Considering first the radiation trapping characteristic of the frusto-conical fins, it is important that the fins of the invention are designed to receive heat from a surrounding heat source and transfer that heat into the engine. This direction of heat flow is opposite to that of most commonly used fins, which are used to cool an engine or machine by transferring heat away from the engine into the surrounding atmosphere. Any trapping of radiation would be an undesirable characteristic for cooling fins. The removal of heat with cooling fins is also commonly assisted by an air impeller. Parallel planar fins minimize air flow resistance through the spaces between the fins.

For a Stirling engine, one major mode of heat of heat transfer from a surrounding burner to the engine head is thermal radiation which occurs in the infrared spectrum. When parallel planar fins are used, some of that radiation travels radially of the head, which is generally parallel to the plane of the fins, and therefore impinges directly upon the head or any fin flanges joined to the head. Because angle of incidence equals angle of reflection, with parallel planar fins, that radiation is reflected back out parallel to the plane of the fins, away from the head and back toward the burner. However, as illustrated in FIG. 2 by the arrows 40, with frusto-conical fins, radiation that is radial of the head is reflected by a fin onto the head. In fact, because the frusto-conical surfaces of the fins are inclined to the exterior surface of the cylindrical head 16, radiation at nearly all angles of incidence upon the fins or the head is reflected onto either the head or another fin instead of being reflected back to the burner. Consequently, heat transfer efficiency and rate are improved. Even radiation traveling parallel to the frusto-conical fins is reflected from the head or the flanges onto another fin.

Turning to the effective lengthening of the heat exchanger, the greater the surface area of a heat exchanger that is exposed to the radiation from a heat source, the more heat it can absorb. Because the heat exchangers for an engine have a generally cylindrical configuration, because they surround the head, the heat exchanger surface area is proportional to the length of the heat exchanger. The effective lengthening of the heat exchanger by using conical fins may be considered with reference to FIG. 2. The length D1 of the heat exchanger of FIG. 2 is the distance from a horizontal plane through the upper edge 22 of the top fin 42 to a horizontal plane through the lower edge 44 of the bottom fin 46. However, if the fins were parallel planar fins, the length of the heat exchanger would be D2. The difference between those length is D3. Consequently, the effective heat absorbing length of the frusto-conical heat exchanger is increased by D3. This effective increase in its thermal absorption length has not changed the length of the attachment region along the head to which the fins are attached. The attachment region length is D2 for both parallel planar fins and frusto-conical fins.

While certain preferred embodiments of the present invention have been disclosed in detail, it is to be understood that various modifications may be adopted without departing from the spirit of the invention or scope of the following claims.

1. A method for fabricating a heat exchanger, the method comprising:
(a) forming a thermally conductive sheet into substantially frusto-conical contour to form at least one fin; and
(b) rolling an edge of the sheet to form a flange along an interior edge of the frusto-conical fin.

2. A method in accordance with claim 1 wherein the thermally conductive sheet is a metal ribbon and the method more particularly comprises:
(a) rolling a first edge of the ribbon to form a flange;
(b) cutting a plurality of spaced, lateral slots into a second edge of the ribbon and extending partially across the ribbon; and
(c) bending the ribbon into the substantially frusto-conical contour and to extend lengthwise along a helix with the flange on the interior of the ribbon and the slots opening outwardly.

3. A method in accordance with claim 2 and more particularly comprising:
(a) said bending the ribbon into a helix, comprises bending the ribbon into a helix having an inside diameter substantially equal to the outside diameter of a cylindrical head of a Stirling engine; and
(b) joining the ribbon along the flange to the head.

4. A method in accordance with claim 1 wherein the thermally conductive sheet is a planar sheet and the method more particularly comprises:
(a) cutting a plurality of rings from said planar sheet;
(b) rolling the inside edge of each ring to form the flange; and
(c) bending each ring into a frusto-conical contour.

5. A method in accordance with claim 4 and more particularly comprising:
(a) cutting the rings and rolling the inside edge to provide an inside diameter of the ring substantially equal the outside diameter of a cylindrical head of a Stirling engine.
(b) positioning each ring around the head in axially spaced arrangement along the head; and
(c) joining each ring along its flange to the head.

6. A heat exchanger for transferring heat to or from a mass and comprising: a plurality of axially spaced fins, each fin formed of a thermally conductive sheet and having a substantially frusto-conical contour.

7. A heat exchanger in accordance with claim 6, each fin further having an inner flange rolled axially along an inner edge of the fin to form a surface for joining each fin to the mass.

8. A beat exchanger in accordance with claim 7, wherein the mass is the head of a Stirling engine and the inner flange of each fin is joined to the head.

9. A heat exchanger in accordance with claim 6 and further comprising a plurality of radial slots in the fins to allow for combustion products to pass through the fins in an axial direction.

10. A heat exchanger in accordance with claim 9 and wherein the radial slots in the fins are aligned in the axial direction.

11. A heat exchanger in accordance with claim 6, wherein the fins are formed in a helix for surrounding the mass.

12. A heat exchange in accordance with claim 6, wherein the fins are formed in a plurality of annular rings for surrounding the mass.

13. A heat exchanger in accordance with claim 6 or 7 or 9 or 10 or 11 or 12 wherein the mass is the head of a Sterling engine.
